(19) United States
(12) Patent Application Publication
(10) Pub. No.: US 2004/0001952 A1
(43) Pub. Date: Jan. 1, 2004

(54) Protective laminate and process for thermal dye sublimation prints

(75) Inventors: William H. Simpson, Pittsford, NY (US); Jacob J. Hastreiter JR., Spencerport, NY (US); Jeanne E. Kaeding, Rochester, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/180,745

(22) Filed: Jun. 26, 2002

(51) Int. Cl. B32B 5/16

(52) U.S. Cl. 428/404; 428/403

(57) ABSTRACT

Disclosed is protective laminate for a thermal dye sublimation print containing a binder and dispersed thermally expandable microspheres having on the surface of the microspheres less than 1.8 wt % of inorganic particulates and a process for forming such a laminate.

### FIELD OF THE INVENTION

This invention relates to a protective laminate for a thermal dye sublimation print containing a binder and dispersed thermally expandable microspheres having on the surface of the microspheres less than 1.8 wt % of inorganic particulates.

### BACKGROUND OF THE INVENTION

In recent years, thermal transfer systems have been developed to obtain prints from pictures that have been generated electronically from a color video camera. According to one way of obtaining such prints, an electronic picture is first subjected to color separation by color filters. The respective color-separated images are then converted into electrical signals. These signals are then operated on to produce cyan, magenta and yellow signals. These signals are then transmitted to a thermal printer. To obtain the print, a cyan, magenta or yellow dye-donor element is placed face-to-face with a dye-receiving element. The two are then inserted between a thermal printing head and a platen roller. A line-type thermal printing head is used to apply heat from the back of the dye-donor sheet. The thermal printing head has many heating elements and is heated up sequentially in response to one of the cyan, magenta and yellow signals. The process is then repeated for the other two colors. A color hard copy is thus obtained which corresponds to the original picture viewed on a screen. Further details of this process and an apparatus for carrying it out are contained in U.S. Pat. No. 4,621,271, the disclosure of which is hereby incorporated by reference.

Thermal prints are susceptible to retransfer of dyes to adjacent surfaces and to discoloration by fingerprints. This is due to dye being at the surface of the dye-receiving layer of the print. These dyes can be driven further into the dye-receiving layer by thermally fusing the print with either hot rollers or a thermal head. This will help to reduce dye retransfer and fingerprint susceptibility, but does not eliminate these problems. However, the application of a protection overcoat will practically eliminate these problems. This protection overcoat is applied to the receiver element by heating in a likewise manner after the dyes have been transferred. The protection overcoat will improve the stability of the image to light fade and oil from fingerprints.

In a thermal dye transfer printing process, it is desirable for the finished prints to compare favorably with color photographic prints in terms of image quality. The look of the final print is very dependent on the surface texture and gloss. Typically, color photographic prints are available in surface finishes ranging from very smooth, high gloss to rough, low gloss matte.

If a matte finish is desired on a thermal print, it has been previously accomplished by using matte sprays or by matte surface applications through post printing processors. However, both of these solutions are costly and add a degree of complexity to the process.

U.S. Pat. No. 6,346,502 and JP 09/323482 relate to the use of expandable microspheres in a transferable protection layer area of a dye-donor element. However, there is a problem with these microspheres in that they cause a build-up of material, or scumming of the unengraved area of the gravure cylinder during manufacture of the dye donor media.

The transferable protection layer of the dye donor is manufactured by a gravure coating process between the temperatures of 12° C. and 49° C. (55° F. and 120° F.), preferably between 18° C. and 38° C. (65° F. and 100° F.). A coating melt or solution is prepared from a solvent soluble polymer and thermally expandable microspheres and is transferred in the liquid state from the etching of the gravure cylinder to the dye donor support. The unengraved area of the cylinder must be kept free of any accumulation of liquid coating melt such that unwanted transfer of liquid to the dye donor support is avoided. Such transfer leads to undesirable contamination of the dye donor support when subsequent patches of dye are coated.

Colloidal silica is added to the surface of the expandable microspheres during manufacture to prevent coalescence of the oil phase droplets during manufacture and agglomeration of the dry microspheres during storage. It is believed that the colloidal silica on the surface of the microspheres interacts with the polymer in the coating melt, which results in a scum forming on the gravure cylinder. The scum builds up with time to a point where the coating machine must eventually be shut down and the scummed cylinder replaced with a clean cylinder because of the unwanted transfer of liquid coating melt to the donor web described above.

It is a problem to be solved to provide a protective laminate for a thermal dye sublimation donor element containing thermally expandable microspheres that exhibits improved resistance to scumming.

### SUMMARY OF THE INVENTION

The invention provides a protective laminate for a thermal dye sublimation print containing a binder and dispersed thermally expandable microspheres having on the surface of the microspheres less than 1.8 wt % of inorganic particulates. The invention also provides a process for removing the particulates.

The laminate of the invention is easier to manufacture (exhibits improved resistance to scumming) and has improved gloss, i.e. a lower level of gloss, giving a more matte finish.

### DETAILED DESCRIPTION OF THE INVENTION

As used herein, the Scum Time is the time to observation of the first undesirable scumming. Higher/longer values are better.

The invention is summarized above. The laminate contains inorganic particles, a polymeric binder and unexpanded synthetic thermoplastic polymeric microspheres, the microspheres having a particle size in the unexpanded condition of from about 5 to about 20 μm, where the silica has been removed from the surface of thermally expandable microspheres by a chemical method. The microspheres stripped of silica do not cause the scumming or hazing problems of the gravure cylinder and advantageously lower the level of gloss when compared to the unstripped microspheres.

By use of the invention, a dye-donor element is provided containing a transferable protection layer that is capable of giving a low gloss or matte surface to an image and can be coated with significant improvement in down time due to cylinder scumming.

In a preferred embodiment of the invention a coating melt, containing thermally expandable microspheres which have been stripped of silica on the surface is used to produce a heat-transferable over-protective layer which can be patch coated with significantly improved downtime due to scumming of the coating cylinder.

In another preferred embodiment of the invention, the dye-donor element is a polychrome element and comprises repeating units of four or more areas, with one area comprising a heat transferable layer.

In another preferred embodiment of the invention, the dye-donor element is a monochrome element and comprises repeating units of two areas, the first area comprising a layer of one image dye dispersed in a binder, and the second area comprising the protection layer.

In another preferred embodiment of the invention, the dye-donor element is a black-and-white element and comprises repeating units of two areas, the first area comprising a layer of a mixture of image dyes dispersed in a binder to produce a neutral color, and the second area comprising the protection layer.

In a preferred embodiment of the invention, the expandable microspheres are colorless, spherically-formed, hollow particles of a thermoplastic shell encapsulating a low-boiling, vaporizable substance, such as a liquid, which acts as a blowing agent. When the unexpanded microspheres are heated, the thermoplastic shell softens and the encapsulated blowing agent expands, building pressure. This results in expansion of the microsphere.

The expandable microspheres employed in the invention may be formed by encapsulating isopentane, isobutane or any other low-boiling, vaporizable substance into a microcapsule of a thermoplastic resin such as a vinylidene chloride-acrylonitrile copolymer, a methacrylic acid ester-acrylonitrile copolymer or a vinylidene chloride-acrylic acid ester copolymer. These microspheres are available commercially as Expancel® Microspheres 461-20-DU, 6-9 μm particle diameter weighted average, (Expancel Inc.); Expancel® Microspheres 461-DU, 9-15 μm particle diameter weighted average, (Expancel Inc.); and Expancel® Microspheres 091-DU, 10-16 μm particle diameter weighted average, (Expancel Inc.).

The present invention provides a protection overcoat layer on a thermal print by uniform application of heat using a thermal head. After transfer to the thermal print, the protection layer provides superior protection against image deterioration due to exposure to light, common chemicals, such as grease and oil from fingerprints, and plasticizers from film album pages or sleeves made of poly(vinyl chloride). The protection layer is generally applied at coverage of at least about 0.03 g/m² to about 1.5 g/m² to obtain a dried layer of less than 1 μm.

As noted above, the transferable protection layer comprises the microspheres dispersed in a polymeric binder. Many such polymeric binders have been previously disclosed for use in protection layers. Examples of such binders include those materials disclosed in U.S. Pat. No. 5,332,713, the disclosure of which is hereby incorporated by reference. In a preferred embodiment of the invention, poly(vinyl acetal) is employed.

Inorganic particles are present in the protection layer of the invention. There may be used, for example, silica, titania, alumina, antimony oxide, clays, calcium carbonate, talc, etc. as disclosed in U.S. Pat. No. 5,387,573. In a preferred embodiment of the invention, the inorganic particles are silica. The inorganic particles improve the separation of the laminated part of the protection layer from the unlaminated part upon printing.

In a preferred embodiment of the invention, the protection layer contains from about 5% to about 60% by weight inorganic particles (not on the microspheres), from about 25% to about 60% by weight polymeric binder and from about 5% to about 60% by weight of the unexpanded synthetic thermoplastic polymeric microspheres.

In use, yellow, magenta and cyan dyes are thermally transferred from a dye-donor element to form an image on the dye-receiving sheet. The thermal head is then used to transfer the clear protection layer, from another clear patch on the dye-donor element or from a separate donor element, onto the imaged receiving sheet by uniform application of heat. The clear protection layer adheres to the print and is released from the donor support in the area where heat is applied.

Any dye can be used in the dye layer of the dye-donor element of the invention provided it is transferable to the dye-receiving layer by the action of heat. Especially good results have been obtained with sublimable dyes. Examples of sublimable dyes include anthraquinone dyes, e.g., Sumikaron Violet RS® (Sumitomo Chemical Co., Ltd.), Dianix Fast Violet 3R FS® (Mitsubishi Chemical Industries, Ltd.), and Kayalon Polyol Brilliant Blue N BGM® and KST Black 146® (Nippon Kayaku Co., Ltd.); azo dyes such as Kayalon Polyol Brilliant Blue BM®, Kayalon Polyol Dark Blue 2BM®, and KST Black KR® (Nippon Kayaku Co., Ltd.), Sumikaron Diazo Black 5G ®(Sumitomo Chemical Co., Ltd.), and Miktazol Black 5GH® (Mitsui Toatsu Chemicals, Inc.); direct dyes such as Direct Dark Green B® (Mitsubishi Chemical Industries, Ltd.) and Direct Brown M® and Direct Fast Black D®) (Nippon Kayaku Co. Ltd.); acid dyes such as Kayanol Milling Cyanine 5R® (Nippon Kayaku Co. Ltd.); basic dyes such as Sumiacryl Blue 6G® (Sumitomo Chemical Co., Ltd.), and Aizen Malachite Green® (Hodogaya Chemical Co., Ltd.);

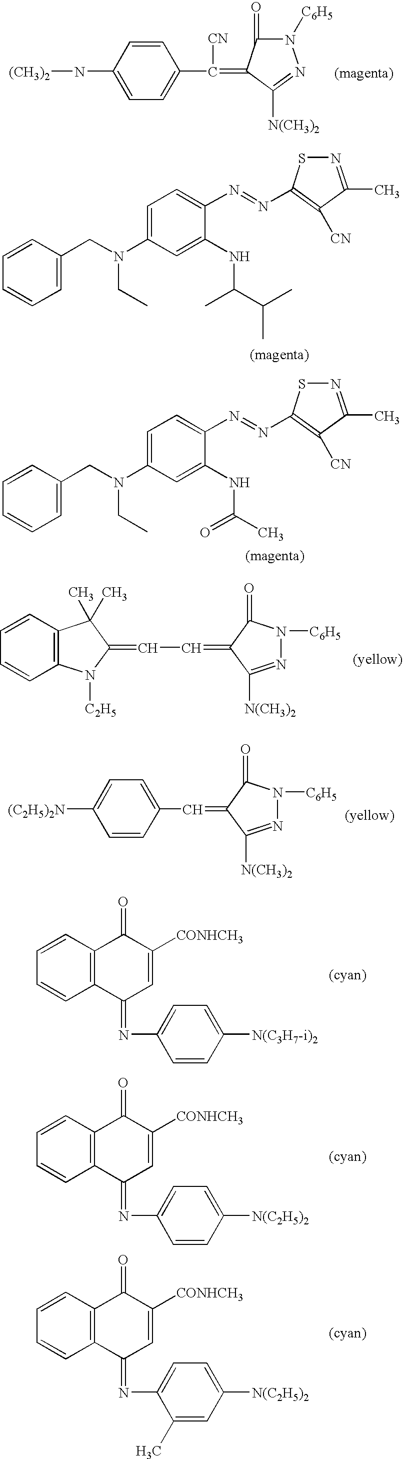

or any of the dyes disclosed in U.S. Pat. No. 4,541,830, the disclosure of which is hereby incorporated by reference. The above dyes may be employed singly or in combination to obtain a monochrome. The dyes may be used at a coverage of from about 0.05 to about 1 g/m² and are preferably hydrophobic.

A dye-banier layer may be employed in the dye-donor elements of the invention to improve the density of the transferred dye. Such dye-barrier layer materials include hydrophilic materials such as those described and claimed in U.S. Pat .No. 4,716,144.

The dye layers and protection layer of the dye-donor element may be coated on the support or printed thereon by a printing technique such as a gravure process.

A slipping layer may be used on the back side of the dye-donor element of the invention to prevent the printing head from sticking to the dye donor element. Such a slipping layer would comprise either a solid or liquid lubricating material or mixtures thereof, with or without a polymeric binder or a surface-active agent. Preferred lubricating materials include oils or semi-crystalline organic solids that melt below 100° C. such as poly(vinyl stearate), beeswax, perfluoiinated alkyl ester polyethers, poly-caprolactone, silicone oil, poly(tetrafluoroethylene), carbowax, poly(ethylene glycols), or any of those materials disclosed in U.S. Pat. Nos. 4,717,711; 4,717,712; 4,737,485; and 4,738,950. Suitable polymeric binders for the slipping layer include poly(vinyl alcohol-co-butyral), poly(vinyl alcohol-co-acetal), polystyrene, poly(vinyl acetate), cellulose acetate butyrate, cellulose acetate propionate, cellulose acetate or ethyl cellulose.

The amount of the lubricating material to be used in the slipping layer depends largely on the type of lubricating material, but is generally in the range of about 0.001 to about 2 g/m². If a polymeric binder is employed, the lubricating material is present in the range of 0.05 to 50 weight %, preferably 0.5 to 40 weight %, of the polymeric binder employed.

Any material can be used as the support for the dye-donor element of the invention provided it is dimensionally stable and can withstand the heat of the thermal printing heads. Such materials include polyesters such as poly(ethylene terephthalate); polyamides; polycarbonates; glassine paper; condenser paper; cellulose esters such as cellulose acetate; fluorine polymers such as poly(vinylidene fluoride) or poly(tetrafluoroethylene-co-hexafluoropropylene); polyethers such as polyoxymethylene; polyacetals; polyolefins such as polystyrene, polyethylene, polypropylene or methylpentene polymers; and polyimides such as polyimide amides and polyetherimides. The support generally has a thickness of from about 2 to about 30 μm.

The dye-receiving element that is used with the dye-donor element of the invention usually comprises a support having thereon a dye image-receiving layer. The support may be a transparent film such as a poly(ether sulfone), a polyimide, a cellulose ester such as cellulose acetate, a poly(vinyl alcohol-co-acetal) or a poly(ethylene terephthalate). The support for the dye-receiving element may also be reflective such as baryta-coated paper, polyethylene-coated paper, white polyester (polyester with white pigment incorporated therein), an ivory paper, a condenser paper or a synthetic paper such as DuPont Tyvek®.

The dye image-receiving layer may comprise, for example, a polycarbonate, a polyurethane, a polyester, poly(vinyl chloride), poly(styrene-co-acrylonitrile), polycaprolactone or mixtures thereof. The dye image-receiving layer may be present in any amount that is effective for the intended purpose. In general, good results have been obtained at a concentration of from about 1 to about 5 g/m².

As noted above, the dye donor elements of the invention are used to form a dye transfer image. Such a process comprises imagewise heating a dye-donor element as described above and transferring a dye image to a dye receiving element to form the dye transfer image. After the dye image is transferred, the protection layer is then transferred on top of the dye image.

The dye donor element of the invention may be used in sheet form or in a continuous roll or ribbon. If a continuous roll or ribbon is employed, it may have only one dye or may have alternating areas of other different dyes, such as sublimable cyan and/or magenta and/or yellow and/or black or other dyes. Such dyes are disclosed in U.S. Pat. Nos. 4,541,830; 4,698,651; 4,695,287; 4,701,439; 4,757,046; 4,743,582; 4,769,360 and 4,753,922, the disclosures of which are hereby incorporated by reference. Thus, one-, two-, three- or four-color elements (or higher numbers also) are included within the scope of the invention.

In a preferred embodiment of the invention, the dye-donor element comprises a poly(ethylene terephthalate) support coated with sequential repeating areas of yellow, cyan and magenta dye, and the protection layer noted above, and the above process steps are sequentially performed for each color to obtain a three-color dye transfer image with a protection layer on top. Of course, when the process is only performed for a single color, then a monochrome dye transfer image is obtained.

Thermal printing heads that can be used to transfer dye from the dye-donor elements of the invention are available commercially. There can be employed, for example, a Fujitsu Thermal Head FTP-040 MCSOO1, a TDK Thermal Head LV5416 or a Rohm Thermal Head KE 2008-F3.

A thermal dye transfer assemblage of the invention comprises

(a) a dye-donor element as described above, and

(b) a dye-receiving element as described above,

the dye receiving element being in a superposed relationship with the dye donor element so that the dye layer of the donor element is in contact with the dye image-receiving layer of the receiving element.

The above assemblage comprising these two elements may be preassembled as an integral unit when a monochrome image is to be obtained. This may be done by temporarily adhering the two elements together at their margins. After transfer, the dye-receiving element is then peeled apart to reveal the dye transfer image.

When a three-color image is to be obtained, the above assemblage is formed on three occasions during the time when heat is applied by the thermal printing head.

After the first dye is transferred, the elements are peeled apart. A second dye-donor element (or another area of the donor element with a different dye area) is then brought in register with the dye-receiving element and the process is repeated. The third color is obtained in the same manner. Finally, the protection layer is applied on top.

The silica is removed from the surface of the thermally expandable microspheres using an alkaline solution with a pH greater than 11, preferably from 12 to 14. An inorganic base, such as sodium or potassium hydroxide, or an organic base such as tetraethylammonium hydroxide, can be used in the stripping process. A mixture of the alkaline materials can also be used.

To facilitate re-dispersion into the coating melt of the microspheres with the reduced silica levels, any surface treatment can be employed that will effect a stable dispersion without adversely affecting the microspheres themselves. It is not desirable to use any treatment that will attack the microspheres themselves. The microspheres can be washed with organic solvent and/or the microspheres can be treated with various surfactants. Surfactants can be either solvent soluble or water soluble, anionic, cationic, or non-ionic. Such compounds may contain, for example, alkyleneimine groups of 2-4 carbon atoms and may also typically contain a poly(carbonylalkyleneoxy) group. Such polyethyleneimines are conveniently employed and a molecular weight of from 10,000 to 50,000 or typically 20,000 to 30,000 is typically employed. A preferred surfactant of this type is SOLSPERSE 24,000 supplied by ICI. Also useful are polyglycoside surfactants that are generally alkyl polyglycoside compounds wherein the derivative contains an alkyl chain of at least 8 carbon atoms, desirably 8 to 16 carbon atoms and contains from 1 to 4 glycoside rings and exhibits an HLB of from 11 to 14. A preferred example of this type is a nonionic sugar derivative is APG® 325 Glycoside (Henkel Corp.).

The solvent treatment can incorporate any organic solvent that will not attack the microspheres. Mild solvents such as toluene are useful for this purpose.

The surfactant and/or solvent treatment does not further reduce the silica content but causes the microspheres to re-disperse in a stable manner.

### EXAMPLES

### Preparation of the Silica Stripped Microspheres

### Inventive Example A

### Removal of Silica from Commercial Expancel® Microspheres (Expancel, Inc.) And Subsequent Solvent Wash

Into a large beaker, equipped with a magnetic stir bar, is placed 2000 g distilled water and 39 g sodium hydroxide pellets. The mixture is stirred until the solid is dissolved and the temperature brought up to 40° C. Next, 2000 g of Expancel®461-20-DU polymer microspheres (Expancel Inc., division of Akzo Nobel) are added slowly to the solution. The mixture is stirred for 2.5 hours. The microspheres are filtered off, and slurried again into distilled water, filtered again, and rinsed. The slurry, filter, and rinse procedure is repeated until the filtrate is neutral. A small sample of the wet cake is air dried and found to contain 0.24% silica. For comparison, the Expancel® microspheres as received form the manufacturer contain 1.80% silica. The damp cake is split in half One half of the cake is used in Inventive Example B below.

The second half of the water damp cake is dispersed again into 2250 g isopropyl alcohol, stirred, and filtered. The alcohol-wet cake is then dispersed again into 2250 g toluene, stirred for one hour, and filtered. The sample is then air dried, to give 685 g of material.

### Inventive Example B

### Removal of Silica from Commercial Expancel® Microspheres and Subsequent Surfactant Treatment

One half of the damp cake with silica removed, prepared in Inventive Example A above, was slurried again in a 3.2% weight solution of APG® 325 Glycoside (Henkel Corp), a non-ionic surfactant of the C9-C11 alkylpolysaccharide ether type, and stirred for 1.5 hours. The slurry was then filtered and the damp cake air-dried, to give 727 g of material.

In the following examples coating melts were prepared according to the following formulas:

| | |
|---|---|
| MATERIAL | Weight % Solids |

Control Element C-1

| | |
|---|---|
| Polyvinylacetal, KS-1, Sekisui Co | 7.1 |
| Butvar B-76, polyvinylbutyral, Solutia Chemical | 0.71 |
| Colloidal silica, MA-ST-M, Nissan Chemical | 13.4 |
| Expancel 461-20-DU, unstripped, Expancel, Inc. | 5.3 |

Inventive Example A

| | |
|---|---|
| Polyvinylacetal, KS-1, Sekisui Co | 7.1 |
| Butvar B-76, Solutia Chemical | 0.71 |
| Colloidal silica, MA-ST-M, Nissan Chemical | 13.4 |
| Expancel 461-20-DU, Inventive sample A. | 5.3 |

Inventive Example B

| | |
|---|---|
| Polyvinylacetal, KS-1, Sekisui Co | 7.1 |
| Butvar B-76, Solutia Chemical | 0.71 |
| Colloidal silica, MA-ST-M, Nissan Chemical | 13.4 |
| Expancel 461-20-DU, Inventive sample B. | 5.3 |

The coating melts above were placed in a gravure-coating machine with a clean gravure cylinder previously mounted. The gravure cylinder was rotated at normal coating speed while wetted with the coating melts. The time to observation of the first undesirable scumming is given in Table 1 below.

| Sample | Scum Time (hours) |
|---|---|
| Control Element C-1 | 0.75 |
| Inventive Example A | >5.5 |
| Inventive Example B | >5.5 |

The coating melts containing thermally expandable microspheres from Inventive Examples A and B give significantly longer Scum Times than that of the control coating melt, which contained microspheres with silica on the surface.

Desirable lower level of gloss from expandable microspheres stripped of silica:

Control element C-2:

The following protection layer donor element was prepared by coating on the back side of a 6 μm poly(ethylene terephthalate) support:

1) a subbing layer of titanium alkoxide, Tyzor TBT®, (DuPont Corp.) (0.13 g/m²) from a n-propyl acetate and n-butyl alcohol solvent mixture (85/15), and

2) a slipping layer containing an aminopropyl-dimethyl-terminated polydimethylsiloxane, PS513® (United Chemical Technologies) (0.01 g/m²), a poly(vinyl acetal) binder, KS-1, (Sekisui Co.), (0.38 g/m²), p-toluenesulfonic acid (0.0003 g/m²) and candellila wax (0.02 g/m²) coated from a solvent mixture of diethylketone, methanol and distilled water (88.7/9.0/2.3).

On the front side of the element was coated a transferable overcoat layer of poly(vinyl acetal), KS-1, (Sekisui Co.), at a laydown of 0.432 g/m², colloidal silica, MA-ST-M (Nissan Chemical Co.), at a laydown of 0.335 g/m², Expancel® microspheres 461-20-DU (Expancel Inc.), at a laydown of 0.323 g/m², and coated from a 75% 3-pentanone and 25% methanol solvent mixture.

### Inventive Example A-1

A heat transferable protection layer as in control element C-2 except that the Expancel microspheres are replaced with those treated in inventive example A above.

### Inventive Example B-1

A heat transferable protection layer as in control element C-2 except that the Expancel microspheres are replaced with those treated in inventive example B above.

Receiving Element

Kodak Ektatherm® receiving element, Catalog #172-5514, was used in the printing technique outlined below to produce the matte type images for measurement of gloss.

Printing

Using Kodak Professional EKTATHERM XLS XTRALIFE Color Ribbon (Eastman Kodak Co. Catalog No. 807-6135) and a Kodak Model 8650 Thermal Printer, a Status A neutral density image with a maximum density of at least 2.3 was printed on the receiver described above. The color ribbon-receiver assemblage was positioned on an 18 mm platen roller and a TDK thermal head (No. 3K0345) with a head load of 6.35 Kg was pressed against the platen roller. The TDK 3K0345 thermal print head has 2560 independently addressable heaters with a resolution of 300 dots/inch and an average resistance of 3314Ω. The imaging electronics were activated when an initial print head temperature of 36.4° C. had been reached. The assemblage was drawn between the printing head and platen roller at 16.9 mm/sec. Coincidentally, the resistive elements in the thermal print head were pulsed on for 58 μsec every 76 μsec. Printing maximum density required 64 pulses “on” time per printed line of 5.0 msec. The voltage supplied was 13.6 volts resulting in an instantaneous peak power of approximately 58.18×10₋₃ Watt/dot and the maximum total energy required to print Dmax was 0.216 mJoules/dot. The process is repeated sequentially, yellow, magenta, cyan to obtain the desired neutral image.

Each of the protective layer elements described above was placed in contact with the polymeric receiving layer side of the receiver element containing the neutral density image described above. The printing process was used to heat the transferable protection overcoat uniformly with the thermal head to permanently adhere the transferable protection overcoat to the print. The print energy was varied by changing the head voltage and enable width. The donor support was peeled away as the printer advanced through its heating cycle, leaving the transferable protection overcoat adhered to the imaged receiver.

Gloss

The 60° gloss values were measured using a Byk-Gardner Tri-gloss meter. The readings were done with the meter perpendicular to the printing direction and each value is the average of four readings randomly selected on the sample. The following results were obtained:

TABLE 2

| Sample | 60 Degree Gloss Value |
|---|---|
| Control C-2 | 36 |
| Inventive Example A-1 | 32 |
| Inventive example B-1 | 33 |

The results shown in Table 2 indicate that removing the silica from the surface of the thermally expandable microspheres gives a heat transferable protective layer on the imaged print having a desirable lower gloss level.

The entire contents of the patents and other publications referred to in this specification are incorporated herein by reference.

What is claimed is:

1. A protective laminate for a thermal dye sublimation print containing a binder and dispersed thermally expandable microspheres having on the surface of the microspheres less than 1.8 wt % of inorganic particulates.

2. The laminate of claim 1 wherein there is on the surface of the microspheres less than 1.8 wt % of Si as SiO₂.

3. The laminate of claim 2 wherein there is on the surface of the microspheres less than 1.0 wt % of Si as SiO₂.

4. The laminate of claim 3 wherein there is on the surface of the microspheres less than 0.5 wt % of Si as SiO₂.

5. The laminate of claim 1 wherein the unexpanded microspheres exhibit an equivalent circular diameter (ECD) of 5-20μcm.

6. The laminate of claim 5 wherein the unexpanded microspheres exhibit an ECD of 6-9μm.

7. The laminate of claim 1 wherein the expanded microspheres exhibit an equivalent circular diameter (ECD) of 10-120μm.

8. The laminate of claim 7 wherein the expanded microspheres exhibit an ECD of 5-25μm.

9. The laminate of claim 8 wherein the expanded microspheres exhibit an ECD of 10-20μm.

10. The laminate of claim 1 wherein the size and frequency of the microspheres is sufficient to provide a 60 degree Gloss less than 35.

11. A protective laminate containing a binder and dispersed thermally expandable microspheres having on the surface of the microspheres an amount of Si sufficiently low enough to provide a Scum Time greater than 3.

12. The laminate of claim 11 wherein the amount of Si is sufficiently low enough to provide a Scum Time greater than 5.5.

13. A thermal dye donor element comprising the protective laminate of claim 1 wherein the microspheres have an unexpanded size of 5-20μm and are capable of an expanded size of 20-120μm.

14. A process for providing expandable microspheres containing silica on the surface thereof having reduced scum-forming properties, comprising reducing the amount of silica on the surface of the expandable microspheres.

15. The process of claim 14 comprising reducing the amount of silica by contacting the surface of the microspheres with an alkaline material that does not adversely affect the microspheres.

16. The process of claim 15 wherein the alkaline material is an inorganic alkalai.

17. The process of claim 14 comprising the additional subsequent step of contacting the microspheres with a reagent capable of decreasing attraction between the microspheres.

18. The process of claim 17 wherein the reagent is surfactant-containing composition.

19. The process of claim 18 wherein the surfactant is an alkyl polyglycoside or a polyalkyleneimine compound.

20. The process of claim 17 wherein the reagent is an organic solvent composition.

21. The process of claim 20 wherein the organic solvent comprises toluene.
